(19) United States
(12) Patent Application Publication
(10) Pub. No.: US 2023/0248029 A1
(43) Pub. Date: Aug. 10, 2023

(54) Single-Serving Beverage Ingredient Containers Comprising Nanoparticulate Cannabidiol

(71) Applicant: Colorado School of Mines, Golden, CO (US)

(72) Inventors: Anuj Chauhan, Golden, CO (US); Zachary Sparks, Golden, CO (US)

(21) Appl. No.: 18/166,877

(22) Filed: Feb. 9, 2023

Related U.S. Application Data
(60) Provisional application No. 63/308,143, filed on Feb. 9, 2022.

(51) Int. Cl. A23L 5/00; B65D 85/804; A23L 29/00

(52) U.S. Cl. CPC A23L 5/55; B65D 85/8067; A23L 29/03

(57) ABSTRACT

Disclosed are single-serving coffee containers in which nanoparticulate CBD, embedded or encapsulated in a hydrophilic thin film, is deposited in a lower portion of the single-serving coffee container below a packed bed of ground coffee beans. The container may, but need not, include a separator that separates the container into an upper portion containing the ground coffee beans and the lower portion containing the CBD nanoparticles. Disclosed methods of using such single-serving coffee containers include exposing the hydrophilic CBD thin film to hot water used in brewing a coffee beverage, thereby causing a carrier material of the hydrophilic thin film to dissolve or disintegrate, thereby releasing the CBD nanoparticles to form a CBD coffee beverage.

### CROSS REFERENCE TO RELATED APPLICATION

This application claims priority under 35 U.S.C. § 119(e) to U.S. Provisional Patent Application 63/308,143, filed 9 Feb. 2022, the entirety of which is incorporated herein by reference.

### FIELD

The present disclosure is directed generally to single-serving beverage ingredient containers, and particularly to single-serving containers comprising cannabidiol in nanoparticulate form and methods for making and using such containers.

### BACKGROUND

Recent changes in United States laws and regulations have sparked a boom in the cannabis industry. Particularly, while compositions containing the principal psychoactive agent in cannabis, Δ9-tetrahydrocannabinol (THC), are still tightly regulated and controlled, substantially THC-free compositions containing cannabidiol (CBD) have gained much wider legal and social acceptance. Recent estimates place annual sales of CBD compositions at $390 million and forecast rapid growth to a value of $1.3 billion annually by 2022. This strong and increasing demand for CBD compositions is driven by widespread recognition of CBD's usefulness in a variety of therapeutic applications, including as an anti-inflammatory, a pain reliever, and an anxiolytic. The use of CBD compositions in the treatment of anxiety, which afflicts over 15 million Americans, has important advantages relative to conventional medication regimens, including fewer side effects and low or no risk of drug withdrawal if and when treatment ceases. Research into CBD is ongoing and many researchers have identified numerous other potential therapeutic uses for CBD.

Before being incorporated into edible products, CBD compositions for oral administration are often provided as oils (e.g. for sublingual administration) or isolate powders. However, CBD in pure form (whether as an oil or a powder) has a powerfully bitter and earthy flavor that most users find unpleasant. In addition, because CBD is hydrophobic and poorly water-soluble, it suffers from the same issues related to bioavailability as other such drugs when administered orally; the maximum theoretical bioavailability of orally administered CBD is 19%, and in most formulations bioavailability is considerably lower. Thus, given the ease of administration and appeal to users of oral formulations, much attention has been devoted to methods of forming nanosuspensions of CBD in water, which address both of these drawbacks; such nanosuspensions are often referred to in the cannabis industry as “water-soluble” CBD, but are more accurately termed “water-dispersible” CBD.

Beverages, especially coffee, have recently been given more consideration as a delivery vehicle for CBD. Conventionally, CBD is incorporated into coffee by dissolving the CBD in a solvent and spraying the resulting solution on the coffee beans (similar to how flavor chemicals are sprayed onto beans shortly before roasting) or by directly adding CBD oil to the brewed coffee beverage (similar to how syrups are added to brewed coffee beverages to provide flavor and/or sweetness). However, because CBD is hydrophobic and poorly soluble in water, it tends not to disperse throughout the coffee beverage but instead tends to form a film layer on a surface of the beverage. This film also cannot be efficiently taken up by the gastrointestinal tract; thus, the dose of CBD actually delivered to the consumer is much less than the dose of CBD added to the coffee.

Some skilled artisans have attempted to overcome these drawbacks by soaking coffee beans in a CBD tincture (i.e. a high-concentration solution of CBD in ethanol) and claim that by this approach, an exact dose of CBD can be delivered to the coffee beverage and then to the consumer. Particularly, various parameters, such as the concentration of CBD in the tincture, the partition of CBD between the beans and the solvent, and the CBD uptake capacity of the coffee beans may be considered to control the CBD infusion process. However, CBD may or may not effectively permeate the beans in these tinctures, and flavor compounds in the coffee beans themselves (e.g. diterpenes, chlorogenic acids, melanoidins, etc.) are often soluble in the solvents used (most typically ethanol, propylene glycol, or medium-chain triglyceride (MCT) oil), resulting in a reduction in the amount of coffee flavor and caffeine that may be delivered in the brewed beverage. This may be compensated by supplementing the CBD-infused beans or grounds with coffee concentrate or coffee extract, but doing so increases the time and cost of formulating a CBD-infused coffee beverage.

One way of mitigating some of the above-mentioned drawbacks is to simply add CBD powder directly to the ground coffee before brewing the coffee beverage. Because CBD powder tends to be much finer (i.e. have a smaller particle size) than ground coffee, however, obtaining an appropriate dispersion of CBD powder throughout the coffee grounds is a challenge. Additionally, this method can result in highly variable extractions of CBD into the brewed coffee beverage.

### SUMMARY

Embodiments of the present disclosure overcome the limitations of conventional cannabidiol (CBD) beverages (including but not limited to coffee beverages), and methods for making such beverages, by providing single-serving containers in which nanoparticulate CBD, embedded or encapsulated in a hydrophilic thin film, is deposited in a lower portion of the single-serving container below a packed bed of a dry beverage precursor ingredient (e.g. ground coffee beans, tea leaves, hot chocolate mix, etc.). The present disclosure further provides methods for making and using such single-serving containers.

While the present disclosure focuses mainly on coffee beverages, i.e. embodiments in which a dry beverage precursor ingredient comprises ground coffee beans, it is to be expressly understood that, unless otherwise specified, the same teachings can be applied mutatis mutandis to any other beverage made by mixing a hot liquid (typically water or milk) with a dry beverage precursor ingredient, and to methods, systems, devices, and articles of manufacture suitable for preparing such beverages. In addition to coffee, non-limiting examples of such beverages include tea and hot chocolate. Thus, by way of non-limiting example, where the description that follows refers to methods of making a “CBD coffee beverage” using a single-serving container that contains both ground coffee beans and cannabidiol, it will be readily apparent that the same or similar methods may be used to prepare a “CBD tea beverage” (e.g. by substituting tea leaves for ground coffee beans) or a “CBD hot chocolate beverage” (e.g. by substituting a powdered hot chocolate mix for ground coffee beans), and such embodiments are within the scope of the present disclosure.

The teachings of the present disclosure can be extended still further to include methods, systems, devices, and articles of manufacture for preparing still other beverages and/or products, including those that are not necessarily or not usually made by mixing a hot liquid with a dry beverage precursor ingredient. By way of non-limiting example, hydrophilic CBD thin films or CBD nanoemulsions may be provided in combination with containers (e.g. bottles, cans, etc.) of alcoholic beverages, sports drinks, soft drinks, and so on. By way of further non-limiting example, strips of dried gels containing CBD dispersed therein may be provided, which allow the consumer to consume the CBD by placing the dried gel strip in the mouth, causing the gel to dissolve and release the CBD.

In embodiments of methods for making a CBD coffee beverage according to the present disclosure, hot water flowing downward through a packed bed of ground coffee beans in an upper portion of the single-serving coffee container first extracts a complex mixture of chemical compounds from the ground coffee beans, as in conventional coffee brewing processes, and then encounters the hydrophilic CBD film in a lower portion of the single-serving coffee container. Upon contact with the hot water, a carrier material of the hydrophilic CBD film is dissolved, and the embedded or encapsulated nanoparticulate CBD is entrained in and carried away by the flow of hot water. The resulting coffee beverage thus comprises nanoparticulate CBD. Embodiments of the present disclosure can improve the consistency and reproducibility of CBD coffee beverages (e.g. by ensuring a consistent amount of CBD in each serving), improve the bioavailability (i.e. uptake into the body) of CBD to a consumer of the CBD coffee beverage (due to improved extraction of the CBD into the beverage when the CBD is formulated as nanoparticles), and provide a CBD coffee composition with improved stability and/or shelf life (e.g. by providing the CBD in a dried form).

In one aspect of the present disclosure, a hydrophilic thin film for adding cannabidiol to a beverage comprises a carrier material, comprising an edible film-forming polymer; and cannabidiol (CBD) nanoparticles, dispersed throughout the carrier material, wherein the carrier material is configured to dissolve or disintegrate upon exposure to a hot aqueous liquid to release the CBD nanoparticles into the hot aqueous liquid.

In another aspect of the present disclosure, a method for making a hydrophilic thin film comprises synthesizing a dispersion of cannabidiol (CBD) nanoparticles in a medium comprising a hydrophilic, edible, film-forming polymer; placing a predetermined volume of the dispersion of CBD nanoparticles in a cavity of a container; and removing water from the dispersion of CBD nanoparticles to form the hydrophilic thin film.

In another aspect of the present disclosure, a container for preparation of a single serving of a beverage comprises a body defining a cavity, the cavity having an upper portion and a lower portion; a packed bed of a dry beverage precursor ingredient, disposed within the upper portion of the cavity; and a hydrophilic thin film, comprising cannabidiol (CBD) nanoparticles dispersed throughout a carrier material, disposed within the lower portion of the cavity, wherein the carrier material is configured to dissolve or disintegrate upon exposure to a hot aqueous liquid to release the CBD nanoparticles into the hot aqueous liquid.

In another aspect of the present disclosure, a method for manufacturing a container for preparation of a single serving of a beverage comprises providing a hydrophilic thin film comprising cannabidiol (CBD) in a cavity defined by a body of the container; filling at least a portion of the cavity with a dry beverage precursor ingredient; and sealing the body of the container.

In another aspect of the present disclosure, a method for making a cannabidiol (CBD)-containing beverage, comprises providing a container as disclosed herein; puncturing the first and second puncturable portions of the body of the container; and causing a hot aqueous liquid to flow (i) into the upper portion of the cavity, (ii) through the packed bed of the dry beverage precursor ingredient to extract at least one chemical compound from the dry beverage precursor ingredient, (iii) onto the hydrophilic thin film to cause the carrier material of the hydrophilic thin film to dissolve or disintegrate and thereby release the CBD nanoparticles into the hot aqueous liquid, and (iv) out of the lower portion of the cavity.

In another aspect of the present disclosure, hydrophilic thin film for adding cannabidiol to a beverage comprises a carrier material, comprising an edible film-forming polymer; and cannabidiol (CBD) nanoparticles, dispersed throughout the carrier material, wherein the carrier material is configured to dissolve or disintegrate upon exposure to a hot aqueous liquid to release the CBD nanoparticles into the hot aqueous liquid.

In embodiments, the CBD nanoparticles may be colloidally dispersed throughout the carrier material.

In embodiments, the edible film-forming polymer may be selected from the group consisting of pullulan, hydroxypropyl methylcellulose, carboxymethyl cellulose, sodium carboxymethyl cellulose, hydroxypropyl cellulose, alginate, pectin, carrageenan, gelatin, starch, and gum arabic.

In embodiments, the hydrophilic thin film may further comprise a nonionic surfactant. The nonionic surfactant may, but need not, be a poloxamer.

In another aspect of the present disclosure, a method for making a hydrophilic thin film, comprises synthesizing a dispersion of cannabidiol (CBD) nanoparticles in a medium comprising a hydrophilic, edible, film-forming polymer; placing a predetermined volume of the dispersion of CBD nanoparticles in a cavity of a container; and removing water from the dispersion of CBD nanoparticles to form the hydrophilic thin film.

In embodiments, the synthesizing step may comprise the sub-steps of combining CBD and an aqueous solvent to form a mixture; heating the mixture to melt the CBD to form an aqueous nanosuspension; adding a nonionic surfactant to the aqueous nanosuspension; sonicating and/or cooling the aqueous nanosuspension; and mixing the aqueous nanosuspension with an aqueous solution of the hydrophilic, edible, film-forming polymer.

In embodiments, the hydrophilic, edible, film-forming polymer may be selected from the group consisting of pullulan, hydroxypropyl methylcellulose, carboxymethyl cellulose, sodium carboxymethyl cellulose, hydroxypropyl cellulose, alginate, pectin, carrageenan, gelatin, starch, and gum arabic.

In embodiments, the removing step may be carried out by heating the dispersion of CBD nanoparticles.

In embodiments, the removing step may be carried out by lyophilizing the dispersion of CBD nanoparticles.

In another aspect of the present disclosure, a container for preparation of a single serving of a beverage comprises a body defining a cavity, the cavity having an upper portion and a lower portion; a packed bed of a dry beverage precursor ingredient, disposed within the upper portion of the cavity; and a hydrophilic thin film, comprising cannabidiol (CBD) nanoparticles dispersed throughout a carrier material, disposed within the lower portion of the cavity, wherein the carrier material is configured to dissolve or disintegrate upon exposure to a hot aqueous liquid to release the CBD nanoparticles into the hot aqueous liquid.

In embodiments, the dry beverage precursor ingredient is selected from the group consisting of ground coffee beans, tea leaves, and a powdered hot chocolate mix.

In embodiments, the carrier material may comprise an edible film-forming polymer selected from the group consisting of pullulan, hydroxypropyl methylcellulose, carboxymethyl cellulose, sodium carboxymethyl cellulose, hydroxypropyl cellulose, alginate, pectin, carrageenan, gelatin, starch, and gum arabic.

In embodiments, the body may comprise a first puncturable portion associated with the upper portion of the cavity and a second puncturable portion associated with the lower portion of the cavity, and the container may be configured such that, when the first and second puncturable portions of the body are punctured, an aqueous liquid may flow into the upper portion of the cavity, through the packed bed of the dry beverage precursor ingredient, onto the hydrophilic thin film, and out of the lower portion of the cavity. The container may, but need not, further comprise a filter configured to substantially prevent the dry beverage precursor ingredient from being carried out of the container due to flow of the aqueous liquid.

In another aspect of the present disclosure, a method for manufacturing a container for preparation of a single serving of a beverage comprises providing a hydrophilic thin film comprising cannabidiol (CBD) in a cavity defined by a body of the container; filling at least a portion of the cavity with a dry beverage precursor ingredient; and sealing the body of the container.

In embodiments, the providing step may comprise the sub-steps of synthesizing a dispersion of CBD nanoparticles in a medium comprising a hydrophilic, edible, film-forming polymer; placing a predetermined volume of the dispersion of CBD nanoparticles in the cavity; and removing water from the dispersion of CBD nanoparticles to form the hydrophilic thin film.

In embodiments, the method may further comprise placing a separator over the hydrophilic thin film to protect the hydrophilic thin film during the placing step or during storage or transportation of the container.

In embodiments, the dry beverage precursor ingredient may be selected from the group consisting of ground coffee beans, tea leaves, and a powdered hot chocolate mix.

In another aspect of the present disclosure, a method for making a cannabidiol (CBD)-containing beverage comprises providing a container as described herein; puncturing the first and second puncturable portions of the body of the container; and causing a hot aqueous liquid to flow (i) into the upper portion of the cavity, (ii) through the packed bed of the dry beverage precursor ingredient to extract at least one chemical compound from the dry beverage precursor ingredient, (iii) onto the hydrophilic thin film to cause the carrier material of the hydrophilic thin film to dissolve or disintegrate and thereby release the CBD nanoparticles into the hot aqueous liquid, and (iv) out of the lower portion of the cavity.

In another aspect of the present disclosure, a container for preparation of a single serving of a beverage comprises a body defining a cavity; a packed bed of a dry beverage precursor ingredient, disposed within the cavity; and a colloid comprising cannabidiol (CBD) nanoparticles and at least one surfactant, wherein the colloid is distributed throughout at least a portion of the packed bed.

In embodiments, the dry beverage precursor ingredient may be selected from the group consisting of ground coffee beans, tea leaves, and a powdered hot chocolate mix.

In embodiments, the at least one surfactant may be selected from the group consisting of Tween20, Tween80, Span80, Pluronic F68, sucrose esters, and sodium stearoyl lactylate.

In embodiments, the CBD nanoparticles and the at least one surfactant may be present in the colloid in approximately equal amounts by weight. The CBD nanoparticles and the at least one surfactant may, but need not, each be present in the colloid in an amount of between about 5 wt % and about 50 wt %. The CBD nanoparticles and the at least one surfactant may, but need not, each be present in the colloid in an amount of between about 10 wt % and about 33 wt %.

In embodiments, the body may comprise a first puncturable portion associated with an upper portion of the cavity and a second puncturable portion associated with a lower portion of the cavity, and the container may be configured such that, when the first and second puncturable portions of the body are punctured, an aqueous liquid may flow into the upper portion of the cavity, through the packed bed of the dry beverage precursor ingredient, and out of the lower portion of the cavity. The container may, but need not, further comprise a filter configured to substantially prevent the dry beverage precursor ingredient from being carried out of the container due to flow of the aqueous liquid.

In another aspect of the present disclosure, a method for manufacturing a container for preparation of a single serving of a beverage comprises filling at least a portion of a cavity of a container with a dry beverage precursor ingredient; providing a colloid comprising cannabidiol (CBD) nanoparticles and at least one surfactant in the cavity, in physical contact with the dry beverage precursor ingredient; and sealing the body of the container.

In embodiments, the dry beverage precursor ingredient may be selected from the group consisting of ground coffee beans, tea leaves, and a powdered hot chocolate mix.

In another aspect of the present disclosure, a method for making a cannabidiol (CBD)-containing beverage comprises providing a container as disclosed herein; puncturing the first and second puncturable portions of the body of the container; and causing a hot aqueous liquid to flow (i) into the upper portion of the cavity, (ii) through the packed bed to extract at least one chemical compound from the dry beverage precursor ingredient and at least a portion of the CBD, and (iii) out of the lower portion of the cavity.

In embodiments, the dry beverage precursor ingredient may be selected from the group consisting of ground coffee beans, tea leaves, and a powdered hot chocolate mix.

In another aspect of the present disclosure, a method for making a cannabidiol (CBD)-containing beverage comprises providing a packed bed comprising a dry beverage precursor ingredient and a colloid comprising CBD nanoparticles and at least one surfactant; and brewing the beverage by causing water at a temperature of less than 66° C. to flow through the packed bed.

In embodiments, the dry beverage precursor ingredient may be selected from the group consisting of ground coffee beans, tea leaves, and a powdered hot chocolate mix.

In another aspect of the present disclosure, a method for making a cannabidiol (CBD)-containing beverage comprises brewing a beverage by causing water at a first temperature to flow through a packed bed of a dry beverage precursor ingredient, wherein the first temperature is at least 66° C.; cooling the beverage, or allowing the beverage to cool, to a second temperature, wherein the second temperature is less than 66° C.; and mixing a colloid comprising CBD nanoparticles and at least one surfactant into the beverage.

In embodiments, the dry beverage precursor ingredient may be selected from the group consisting of ground coffee beans, tea leaves, and a powdered hot chocolate mix.

In embodiments, the first temperature may be between 91° C. and 96° C.

In embodiments, the second temperature may be at least about 60° C.

While specific embodiments and applications have been illustrated and described, the present disclosure is not limited to the precise configuration and components described herein. Various modifications, changes, and variations which will be apparent to those skilled in the art may be made in the arrangement, operation, and details of the methods and systems disclosed herein without departing from the spirit and scope of the overall disclosure.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to about 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The embodiments and configurations described herein are neither complete nor exhaustive. As will be appreciated, other embodiments are possible utilizing, alone or in combination, one or more of the features set forth above or described in detail below.

### BRIEF DESCRIPTION OF THE DRAWINGS

FIG. 1 is a flowchart illustrating a method for manufacturing a single-serving coffee container comprising nanoparticulate cannabidiol (CBD), according to embodiments of the present disclosure.

FIG. 2 is a photograph of hydrophilic thin films comprising nanoparticulate CBD, in which sodium carboxymethyl cellulose (SCMC) is a carrier material, according to embodiments of the present disclosure.

FIG. 3A is a photograph of a CBD-SCMC gel being placed into a bottom portion of a capsule adapted for use with a Keurig single-serving coffee machine.

FIG. 3B is a photograph showing the gel of FIG. 3A disposed in the bottom portion of the single-serving coffee capsule.

FIG. 3C is a photograph showing hot water being poured over the gel/capsule assembly of FIG. 3B held in a collection beaker.

FIG. 3D is a photograph of a filter of the single-serving coffee capsule after dissolution of the CBD-SCMC gel due to exposure to hot water.

FIG. 4A is a photograph illustrating samples of three different CBD/Tween20 colloids.

FIG. 4B is a photograph illustrating samples of three different 10 wt % CBD/10 wt % Tween80 colloids.

FIG. 4C is a photograph illustrating samples of CBD colloids made using each of four different surfactants.

FIG. 5A is a photograph illustrating a CBD coffee beverage brewed from a mixture of ground coffee beans and pure CBD powder.

FIG. 5B is a photograph illustrating a CBD coffee beverage brewed from a mixture of ground coffee beans and a CBD/F68 colloid.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. In the event that there is a plurality of definitions for a term herein, the definition provided in the Summary prevails unless otherwise stated.

Unless defined otherwise, all technical and scientific terms used herein have the same meaning as is commonly understood by one of ordinary skill in the art. All patents, applications, published applications, and other publications to which reference is made herein are incorporated by reference in their entirety. In the event that there is a plurality of definitions for a term herein, the definition provided in the Summary of the Invention prevails unless otherwise stated.

As used herein, unless otherwise specified, the term “colloid” refers to a mixture in which particles of one substance (the “dispersed phase”) are dispersed throughout a volume of a different substance (the “dispersion medium”). For example, the dispersed phase can comprise or consist of microscopic bubbles, particles, etc. Where the dispersed phase and the dispersion medium of a colloid are specifically identified herein, they are separated by a hyphen, with the dispersed phase identified first, e.g. a reference herein to a “CBD-polymer colloid” refers to a colloid in which cannabidiol (CBD) is the dispersed phase and a polymer is the dispersion medium.

Embodiments of the present disclosure include single-serving coffee containers, within which are placed hydrophilic thin films comprising a carrier material, such carrier material acting as a dispersion medium in which nanoparticles of cannabidiol (CBD) are dispersed; in these embodiments, the hydrophilic thin film can thus be considered a colloid, as that term is used herein. The carrier material is configured to dissolve or disintegrate upon exposure to a hot aqueous liquid to release the CBD nanoparticles into the hot aqueous liquid. The hydrophilic thin films are placed in a lower portion of the single-serving coffee container, below a packed bed of ground coffee beans. Thus, when a single-serving coffee container according to the present disclosure is used in a beverage brewing process, hot water flows downward from the top of the single-serving coffee container, through the packed bed of ground coffee beans (thereby extracting a complex mixture of chemical compounds, including aroma and flavor compounds, characteristic of coffee beverages), and then onto or around the hydrophilic CBD thin film, whereupon the carrier material of the hydrophilic CBD thin film dissolves or disintegrates to release CBD nanoparticles into the hot liquid and produce a CBD coffee beverage.

In embodiments, hydrophilic thin films according to the present invention are configured to be dissolved, disintegrated, or physically or chemically disrupted upon exposure to hot water as part of a coffee brewing process. Particularly, hydrophilic thin films according to the present invention may incorporate one or more edible or food-safe polymers as carrier materials that form a matrix or network that is disrupted during a cooking process. These edible and/or food-safe polymeric carrier materials may facilitate the breakdown of the hydrophilic thin film by any one or more mechanisms, such as, by way of non-limiting example, dissolution (e.g. of a water-soluble polymer by the hot water), melting or other thermally-induced change (e.g. upon exposure to the high temperatures of coffee brewing water), and the like. It is to be expressly understood that hydrophilic thin films may be configured to undergo physical breakdown or disruption by two or more mechanisms.

Most generally, the carrier material(s) of hydrophilic thin films of the present disclosure can be any food-safe material suitable for dispersion of cannabidiol. Typically, however, these materials will most suitably be an edible film-forming polymer, or a combination of two or more edible film-forming polymers, due to their safety for use in food preparation, convenience, relatively low cost, and ease of manufacturing. Even more specifically, it may in some embodiments be desirable to select one or more water-soluble film-forming edible polymers, such as a water-soluble polysaccharide, as a carrier material; such water-soluble film-forming edible polymers tend to rapidly dissolve or disintegrate upon exposure to hot water, such as during a coffee brewing process. Examples of water-soluble film-forming polymers suitable for use as carrier materials of hydrophilic thin films of the present invention include, but are not limited to, pullulan, hydroxypropyl methylcellulose (hypromellose or HPMC), carboxymethyl cellulose (CMC), hydroxypropyl cellulose (HPC), starch, gum arabic, and hydrocolloids (e.g. alginate, pectin, carrageenan, and the like). In some embodiments, one or more film-forming edible polymers that are soluble in water only under select conditions (e.g. polymers whose solubility in water is highly temperature-dependent, such as gelatin or carrageenan) may be provided instead of, or in addition to, the one or more water-soluble film-forming edible polymers to provide an additional or alternative mechanism for the breakdown or transformation of the carrier material.

The hydrophilic thin films of the present disclosure may further comprise a surfactant, preferably a nonionic surfactant, to improve the degree to which CBD nanoparticles are colloidally or otherwise uniformly dispersed throughout the carrier material. Non-limiting examples of suitable surfactants include poloxamers, such as Pluronic F68.

In embodiments, hydrophilic thin films according to the present disclosure may include, in addition to CBD, any one or more food-safe flavoring ingredients. Flavoring ingredients may include sugars, milk solids, or any one or more herbs, spices, etc. commonly used to flavor coffee; non-limiting examples of such flavoring ingredients include cardamom, chocolate, chicory, cinnamon, hazelnut, nutmeg, orange blossom, and vanilla. Flavoring ingredients may be provided in the hydrophilic thin films of the present invention in any one or more suitable physical forms, including but not limited to finely ground solids, coarsely ground solids, liquids, oleoresins, essential oils, and so on.

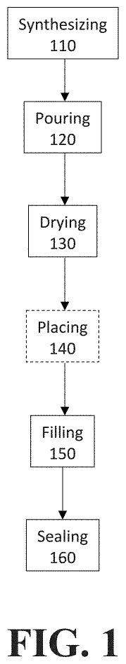

Referring now to FIG. 1, a method 100 for manufacturing a single-serving coffee container according to the present disclosure is illustrated. The method 100 illustrated in FIG. 1 includes a synthesizing step 110, a pouring step 120, a drying step 130, an optional placing step 140, a filling step 150, and a sealing step 160. In the synthesizing step 110 of the method 100 illustrated in FIG. 1, a formulation comprising CBD nanoparticles dispersed throughout a hydrophilic polymer medium is synthesized. In the pouring step 120 of the method 100 illustrated in FIG. 1, a predetermined volume of the CBD nanoparticle formulation is poured into a body of a container, for example a plastic or metal capsule (e.g. a capsule adapted for use in, by way of non-limiting example, a Keurig or Nespresso machine) or a paper pod (e.g. an Easy Serving Espresso (ESE) pod or a pod adapted for use with, by way of non-limiting example, a Senseo machine). In the drying step 130 of the method 100 illustrated in FIG. 1, the CBD nanoparticle formulation is dried to form a hydrophilic thin film within which are embedded or encapsulated CBD nanoparticles. In the optional placing step 140 of the method 100 illustrated in FIG. 1, a separator is placed on or over the hydrophilic CBD thin film to protect the film from breakup during filling step 150 and/or during storage or transportation of the single-serving coffee container. In the filling step 150 of the method 100 illustrated in FIG. 1, at least a portion of the remaining volume within the body of the container is filled with ground coffee beans. In the sealing step 160 of the method 100 illustrated in FIG. 1, the container is sealed to form the single-serving coffee container.

The inventive aspects of the present disclosure are further described and illustrated by way of the following non-limiting Examples.

### EXAMPLE 1

### CBD Gel Synthesis

Sodium carboxymethyl cellulose (SCMC) was dissolved in 10 mL deionized water in scintillation vials to form a 2 wt % SCMC solution. This SCMC aqueous solution was then heated (on a hot plate set to 150° C.) and stirred (530 rpm) for 10 minutes. Separately, Pluronic F68 was added to water in a 500 mL glass bottle, and the resulting mixture was mixed for 10 minutes at room temperature, to form a 15 wt % F68 solution.

Subsequently, 200 mg of CBD was mixed with 2.67 mL deionized water in a scintillation vial, and the resulting mixture was heated (on a hot plate set to 150° C.) and stirred (530 rpm) for 8 minutes, until the CBD was dissolved. 7.33 mL of the 15 wt % F68 solution was added to the scintillation vial and the mixture was sonicated on ice at 125 W for 1 minute to form 10 mL of a melt-emulsified 2 wt % CBD/4 wt % F68 aqueous solution, with the F68 acting as a surfactant.

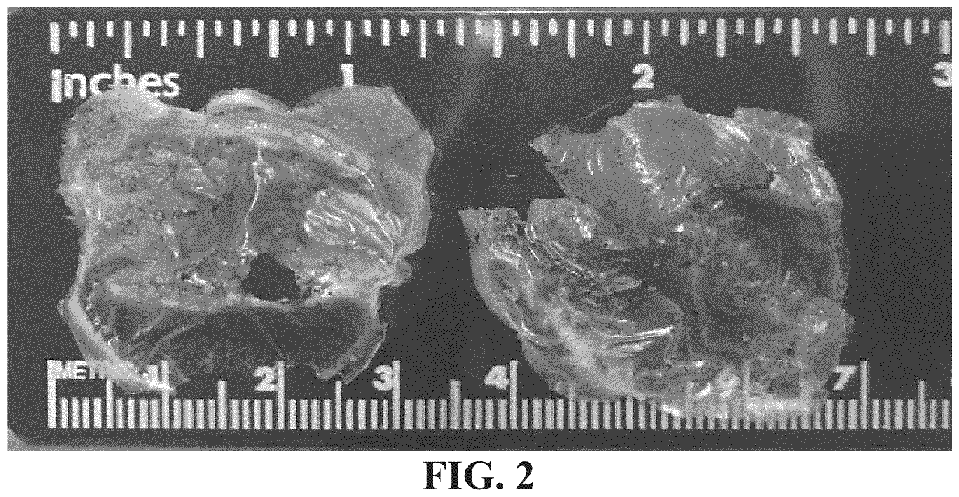

Equal parts by weight of the SCMC solution and the CBD/F68 solution were mixed in a centrifuge tube and vortexed for 30 seconds. Multiple samples of the resulting mixed solution were produced by either depositing 2 mL of the mixed solution on a glass or plastic surface or adding 4 mL of the mixed solution to the bottom of a plastic capsule adapted for use with a Keurig single-serving coffee machine. The glass and plastic surfaces and the plastic capsules were placed in an oven at about 115° C. for 1 hour to facilitate fast drying of the solution, and the samples were then transferred to an incubator (37° C.) and left to further dry overnight to form a hydrophilic CBD thin film. Samples of the resulting gels are illustrated in FIG. 2.

It is to be expressly understood that water can be removed from the liquid CBD solution by, in addition to or instead of the heating carried out in this Example, any drying method, including but not limited to freeze-drying/lyophilizing (i.e. freezing the formulation and sublimating water under vacuum). The present inventors hypothesize that in some embodiments, freeze-drying/lyophilizing may improve the stability of the resulting formulation by preventing aggregation of the CBD nanoparticles as water is removed, thereby resulting in a smaller CBD particle size that allows for improved extraction into a CBD coffee beverage. The present inventors further hypothesize that freeze-drying/lyophilizing would also form a film having a more porous structure, which may improve the flow of water through the film during the coffee brewing process.

The procedure of this Example was repeated numerous times, varying the total contents of SCMC and F68 in the final gel and the drying method, to produce numerous hydrophilic CBD thin films. These hydrophilic CBD thin films were further used in the following Examples 2-5.

### EXAMPLE 2

### CBD Gel Dissolution

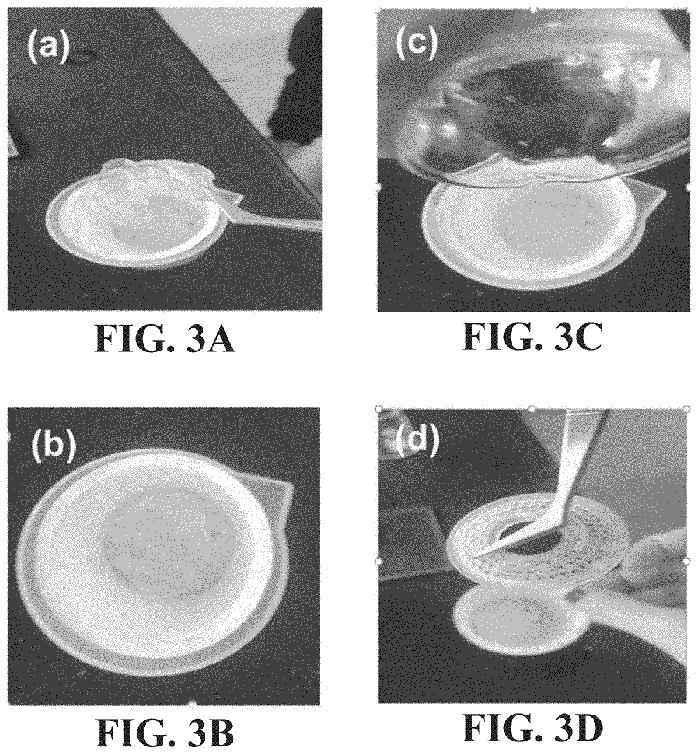

The ground coffee was removed from a single-serving coffee container adapted for use in a Keurig single-serving coffee machine and two holes were punctured in a bottom wall of the container (as occurs during normal operation of such a machine). A hydrophilic CBD thin film made in Example 1 was then placed in the bottom of the capsule, as illustrated in FIGS. 3A and 3B. The capsule was then placed in a collection beaker, and 50 to 60 mL of deionized water was boiled and poured into the capsule over the thin film, as illustrated in FIG. 3C. Referring now to FIG. 3D, removing the filter from the bottom of the single-serving coffee container reveals that the hydrophilic CBD gel has been completely dissolved—no gel material remains at the bottom of the container.

### EXAMPLE 3

### CBD Coffee Beverage

The ground coffee and filter were removed from a single-serving coffee container adapted for use in a Keurig single-serving coffee machine. A hydrophilic CBD thin film made in Example 1 was then placed in the bottom of the capsule, and the film was re-covered with the removed coffer and filter. The capsule was placed in a Keurig machine, which was then operated to brew a 260 mL cup of a CBD coffee beverage.

The procedure of this Example was repeated numerous times using the various CBD thin films produced in Example 2. The CBD coffee beverages thus produced were further used in the Examples that follow.

### EXAMPLE 4

### Dynamic Light Scattering

The CBD coffee beverages produced in Example 3 were filtered with 0.45 μm filters and diluted with water until completely clear. A Malvern Instruments Nano ZS dynamic light scatterer with a high-power laser (50 mW, 532 nm) was used to determine the hydrodynamic diameters of the CBD nanoparticles within each aqueous CBD dispersion. Each of the CBD coffee beverages produced according to Example 3 was tested in triplicate (10 runs, 30 seconds) by taking 100 μL samples via plastic cuvette at 90°; the intensity-weighted size distribution was obtained from combined runs. The results are illustrated in Table 1 below; in the column labeled “Drying surface,” “capsule” means that the film was dried in a plastic capsule adapted for use with a Keurig single-serving coffee machine.

TABLE 1

| | | | | | CBD |
|---|---|---|---|---|---|
| | | | | Mean CBD | particle size |
| | SCMC | F68 | Drying | particle size | std. dev. |
| Sample # | wt % | wt % | surface | (nm) | (nm) |
| 1 | 1 | 2 | Plastic | 217 | 15.3 |
| 2 | 1 | 2 | Plastic | 165.4 | 18.7 |
| 3 | 1 | 2 | Plastic | 186.5 | 17.2 |
| 4 | 1 | 2 | Glass | 168.9 | 7.6 |
| 5 | 2 | 2 | Glass | 269 | 12.3 |
| 6 | 1 | 4 | Glass | 202.9 | 4.9 |
| 7 | 1 | 2 | Plastic | 297.2 | 4.5 |
| 8 | 2 | 2 | Plastic | 331.4 | 4.447 |
| 9 | 3.5 | 2 | Plastic | 334.2 | 1.305 |
| 10 | 1 | 2 | Glass | 172 | 2.318 |
| 11 | 2 | 4 | Glass | 153.8 | 1.389 |
| 12 | 1 | 2 | Capsule | 274.9 | 3.943 |
| 13 | 1 | 2 | Plastic | 233.3 | 3.7 |

### EXAMPLE 5

### CBD Concentration

An Alliance Waters 2695 separations module was used to perform high-performance liquid chromatography (HPLC) on samples of the CBD coffee beverages produced in Example 3 to determine CBD concentrations therein. Specifically, samples of the CBD coffee beverages were mixed with ethanol at a 50:50 ratio. Acetonitrile was used as the mobile phase in a Sunfire C18 5 μm column (4.6×150 mm). Standards of known concentrations from 0.05 to 1 mg/mL were used. 20 μL samples were injected for 5 minutes, with CBD found to elute at 2.7 minutes. Finally, the area under the curve of absorbance at 254 nm was used to determine the concentration of CBD in the samples, which was then multiplied by the volume of the samples to determine the total mass of CBD in each CBD coffee beverage. The results are given in Table 1 below; in the column labeled “Drying surface,” “capsule” means that the film was dried in a plastic capsule adapted for use with a Keurig single-serving coffee machine.

In Table 1, the “theoretical gel” mass is the combined mass of the CBD, surfactant, and polymer in the deposited mixed solution prior to drying, and the “measured gel” mass is the actual mass of the gel formed after drying, with the “gel loss” representing the normalized difference. Similarly, the “theoretical CBD” mass is the total mass of CBD present in the deposited mixed solution prior to drying and the “measured CBD” mass is the total mass of CBD present in the CBD coffee beverage (as measured by HPLC according to this Example), with the “CBD loss” representing the normalized difference.

TABLE 1

| | | | | Gel | | | CBD | | | | |
|---|---|---|---|---|---|---|---|---|---|---|---|
| | SCMC | F68 | Drying | Theoretical | Actual | Loss | Theoretical | Actual | Loss | Mean CBD | CBD particle size |
| Sample # | wt % | wt % | surface | (mg) | (mg) | (%) | (mg) | (mg) | (%) | particle size (nm) | std. dev. (nm) |
| 1 | 1 | 2 | Plastic | 80 | NR | NR | 20 | 3.04 | 85 | 217 | 15.3 |
| 2 | 1 | 2 | Plastic | 80 | 60.4 | 25 | 20 | 3.10 | 84 | 165.4 | 18.7 |
| 3 | 1 | 2 | Plastic | 80 | 63.2 | 21 | 20 | 2.99 | 85 | 186.5 | 17.2 |
| 4 | 1 | 2 | Glass | 320 | 192.3 | 40 | 80 | 13.65 | 83 | 168.9 | 7.6 |
| 5 | 2 | 2 | Glass | 400 | 310.1 | 22 | 80 | 20.14 | 75 | 269 | 12.3 |
| 6 | 1 | 4 | Glass | 480 | 248.4 | 48 | 80 | 26.08 | 67 | 202.9 | 4.9 |
| 7 | 1 | 2 | Plastic | 80 | 41.7 | 48 | 20 | 9.16 | 54 | 297.2 | 4.5 |
| 8 | 2 | 2 | Plastic | 100 | 64 | 36 | 20 | 8.71 | 56 | 331.4 | 4.447 |
| 9 | 3.5 | 2 | Plastic | 130 | 112.3 | 14 | 20 | 7.87 | 61 | 334.2 | 1.305 |
| 10 | 1 | 2 | Glass | 320 | 55.8 | 83 | 80 | 4.53 | 94 | 172 | 2.318 |
| 11 | 2 | 4 | Glass | 560 | 473.7 | 15 | 80 | 40.75 | 49 | 153.8 | 1.389 |
| 12 | 1 | 2 | Capsule | 160 | 69.4 | 57 | 40 | 9.16 | 77 | 274.9 | 3.943 |
| 13 | 1 | 2 | Plastic | NR | 46.9 | NR | NR | 32.74 | NR | 233.3 | 3.7 |

The present inventors hypothesize that the loss of CBD, i.e. the difference between the mass of CBD loaded in the formulation deposited on the surface or in the capsule prior to drying and the mass of CBD in the prepared CBD coffee beverage, can be attributed to attachment of CBD particles to a wall or surface of the single-serving coffee container. Specifically, it is hypothesized that nanoparticles of CBD may aggregate, as water is evaporated during the drying process, to form larger particles that precipitate to form a distinct CBD-rich layer on a top or bottom of the hydrophilic gel surface. Because CBD is hydrophobic, this separated phase would likely adsorb on the coffee container wall or surface and thus fail to be extracted with the coffee. The present inventors believe that this aggregation of CBD particles can be minimized by preparing a more stable formulation, by drying the mixed precursor solution more rapidly, or by starting with a smaller particles size (e.g. by sonicating at a higher intensity or for a longer time). CBD aggregation could also be minimized by increasing the content of hydrophilic polymer in the solution.

### EXAMPLE 6

### Effect of Surfactant on CBD Colloid Stability

1 g of CBD isolate was added to each of several glass vials and melted on a hot plate under magnetic stirring. Once the CBD powder fully melted, 1 g of one of four surfactants—Tween20, Tween80, Span80, or Pluronic F68—was added to each vial to yield a 50 wt % CBD/50 wt % surfactant mixture, and the stirring and heating were continued until the mixture was homogeneous. Each mixture was then transferred to a syringe and allowed to cool at room temperature. It was observed that the Tween20 and Tween80 formulations were gold liquids that retained high clarity upon cooling and could be extruded dropwise from the syringe; the Span80 formulations were gold liquids that became opaque upon cooling and could be extruded dropwise from the syringe; and the Pluronic F68 formulations were purple mixtures (due to oxidation of polyphenol) that were more viscous than the other mixtures and could not be extruded from the syringe.

Subsequently, either 2 mL or 8 mL of deionized water was added to each mixture under stirring and heat to yield either a 25 wt % CBD/25 wt % surfactant/50 wt % water mixture or a 10 wt % CBD/10 wt % surfactant/80 wt % water mixture, respectively. Once each of these mixtures was homogenized to form a colloid, the colloid was stirred under ambient temperature to cool, then sonicated by sonication probe. It was observed that all 10 wt % CBD formulations and the 25 wt % CBD formulations using the Tween or Span surfactants formed white colloids after mixing and sonication, while the 25 wt % CBD formulation using the Pluronic F68 surfactant formed a purple paste; the latter formulation was diluted with deionized water to 15 wt % CBD/15 wt % surfactant, shaken, vortexed, and sonicated to obtain a white colloid.

Separately, in each of several vials, 500 mg CBD were melted in 0.6 mL water under magnetic stirring. Once the CBD in each of these vials melted, the mixture was moved to a stir plate at ambient temperature and stirred at a higher rate of 800 rpm. When each of these mixtures had cooled to near-ambient temperature, either Pluronic F68 or Pluronic F127 was added to each vial under stirring and stirring was continued until a uniform emulsion was formed. This colloid was then sonicated by sonication probe.

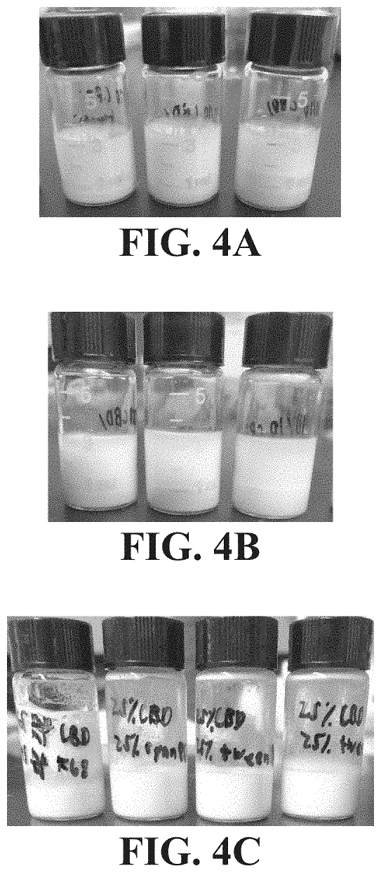

FIG. 4A shows three different 10 wt % CBD/10 wt % Tween20 colloids, which were sonicated for (from left to right) 1, 3, and 5 minutes, respectively, 24 hours after synthesis. FIG. 4B shows three different 10 wt % CBD/10 wt % Tween80 colloids, which were sonicated for (from left to right) 1, 3, and 5 minutes, respectively, 24 hours after synthesis. FIG. 4C shows, from left to right, a 15 wt % CBD/15 wt % F68 colloid, a 25 wt % CBD/25 wt % Span80 colloid, a 25 wt % CBD/25 wt % Tween80 colloid, and a 25 wt % CBD/25 wt % Tween20 colloid 24 hours after synthesis.

It was observed that the colloids that included Tween20 or Tween80 (regardless of CBD/surfactant concentration) had the best shelf stability and were maintained as a white colloid with very little observed settling over at least three weeks of storage at ambient conditions. Although some settling was observed in the colloids that included Span80 (regardless of CBD/surfactant concentration), vortexing these colloids after settling was effective to redisperse the CBD throughout the colloid. 10 wt % CBD colloids that included Pluronic F68 exhibited some settling after 24 hours, significant settling after several days, and essentially complete separation (with a lower CBD phase and a clear purple liquid supernatant phase) after one week, although vortexing was effective to redisperse the CBD after 24 hours. 10 wt % CBD formulations that included Pluronic F127 did not form stable colloid, and Pluronic F127 formulations with higher amounts of CBD formed a paste that completely separated after 24 hours.

Table 2 gives the molecular weight and hydrophilic-lipophilic balance (HLB) of the surfactants used to make CBD colloids in this Example; the molecular weight of CBD is 314.47 g/mol. Without wishing to be bound by any particular theory, the present inventors hypothesize that these are the two surfactant parameters that predominantly control the stability of CBD in the colloid. Particularly, the present inventors hypothesize that the greatest stability is achieved when the molecular weight and/or HLB are neither too low (as in the case of Span80) nor too high (as in the case of Pluronic F68 or F127), but instead are in an intermediate range (as in the case of Tween20 and Tween80).

TABLE 2

| | Molecular weight | |
|---|---|---|
| Surfactant | (g/mol) | HLB |
| Span80 | 428.6 | 4.3 |
| Tween20 | 1,227.5 | 16.7 |
| Tween80 | 1,310 | 15 |
| Pluronic F68 | 8,400 | 29 |
| Pluronic Fl27 | 12,500 | 22 |

The CBD formulations prepared in this Example were further used in Example 8 below.

### EXAMPLE 7

### CBD Extraction in Brewed Coffee Beverage—Pure CBD Powder

To test the extraction efficiency of pure CBD powder in a coffee brewing process, the foil lids of each of several single-serving coffee containers adapted for use in a Keurig single-serving coffee machine were peeled back, a small depression was made in the top of the coffee grounds, and a measured quantity of CBD powder was placed in the depression. The foil lids were then resealed, and the containers were shaken for 30 seconds to disperse the CBD powder throughout the mass of coffee grounds. Each of the containers was then used in a Keurig single-serving coffee machine to brew either a 160 mL coffee beverage or a 300 mL coffee beverage. Mixing the CBD powder throughout the coffee grounds allowed the CBD to melt as hot water flowed downward from the top of the container and through the mass of coffee grounds during the coffee brewing process; relative to simply disposing the CBD powder in the bottom of the container, this reduces the amount of CBD extracted into the coffee beverage but improves the extent to which the CBD is mixed and dispersed with other chemical components extracted with the coffee, thereby inhibiting the formation of a CBD film in the brewed coffee beverage.

For each brewed coffee beverage, the beverage was poured into three separate bottles; a small sample was taken from each bottle and diluted in 10× (by volume) ethanol. This mixture was then shaken and centrifuged to remove coffee components and dissolve the CBD. The supernatant was removed from the centrifuged samples and measured by high-performance liquid chromatography using an Agilent Zorbax Eclipse XDB-C8 column. The mobile phase was a 1 mL/min gradient of 70:30 (vol/vol) acetonitrile:water to 80:20 (vol/vol) acetonitrile:water over 8 minutes. A 20 μL injection was used and the column was kept at 25° C. Absorbance was measured at 210 nm with a 5 nm bandwidth.

Table 3 shows the CBD extraction amounts and efficiencies.

TABLE 3

| | Beverage | CBD in | CBD |
|---|---|---|---|
| CBD mass | volume | beverage | extraction |
| (mg) | (mL) | (mg) | (%) |
| 50 | 160 | 8.9 ± 4.4 | 22.0 ± 9.6 |
| | 300 | 20.3 ± 5.9 | 42.1 ± 10.0 |
| 75 | 160 | 11.3 ± 4.8 | 8.3 ± 6.2 |
| | 300 | 11.9 ± 3.9 | 15.8 ± 5.2 |
| 100 | 160 | 21.0 ± 14.8 | 21.0 ± 14.8 |
| | 300 | 11.9 ± 3.5 | 11.9 ± 3.5 |

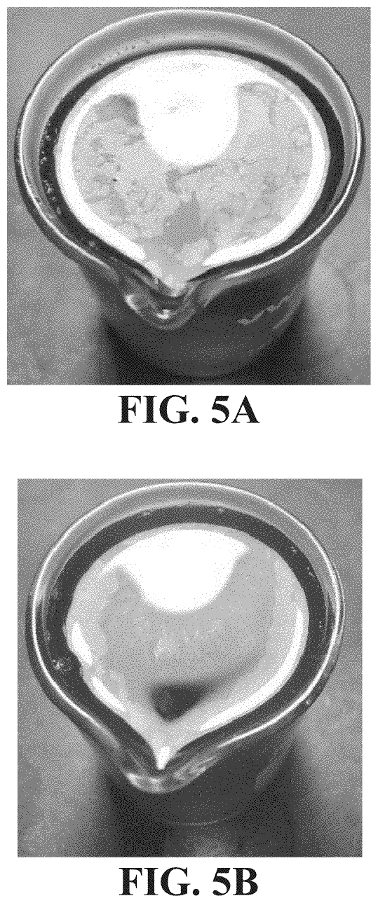

As Table 3 shows, the extraction of CBD from addition of pure CBD powder to single-serving coffee containers was highly variable and provided very little or no control over the dose of CBD in the coffee beverage. This variability is expected due to the difference in particle size between the CBD powder and the ground coffee, which makes uniform dispersion of the CBD powder throughout the coffee grounds difficult. In addition, as FIG. 5A illustrates, the extracted CBD still formed large, thick films on the surface of the coffee beverage; because it is poorly mixed with the coffee beverage, the CBD will be cleared from the user's body quickly and provide little CBD efficacy, and the film itself detracts from the quality and appeal of the beverage.

### EXAMPLE 8

### CBD Extraction in Brewed Coffee Beverage—CBD Colloids

To test the extraction efficiency of the CBD colloids of Example 6 in a coffee brewing process, the foil lids of each of several single-serving coffee containers adapted for use in a Keurig single-serving coffee machine were peeled back, approximately half of the grounds were removed, the CBD colloid was added across the top of the remaining grounds as individual droplets, and the removed grounds were then replaced in the container atop the added droplets of CBD colloid. Each of the containers was then used in a Keurig single-serving coffee machine to brew either a 160 mL coffee beverage or a 300 mL coffee beverage, and the CBD extraction in each beverage was measured as described in Example 7. The results are shown in Table 4. (The CBD colloid was added to the coffee container within 24 hours of the synthesis of the CBD colloid.)

TABLE 4

| | CBD/ | | | | |
|---|---|---|---|---|---|
| | surfactant | Colloid | Beverage | CBD in | CBD |
| | wt % in | vol. | vol. | beverage | extraction |
| Surfactant | colloid | (μL) | (mL) | (mg) | (%) |
| Pluronic | 10/10 | 100 | 160 | 2.0 ± 0.3 | 19.0 ± 3.2 |
| F68 | | | 300 | 3.5 ± 0.8 | 32.4 ± 7.0 |
| | | 300 | 160 | 3.9 ± 0.6 | 14.2 ± 2.3 |
| | | | 300 | 11.4 ± 0.8 | 42.4 ± 2.8 |
| | | 500 | 300 | 11.8 ± 2.0 | 21.8 ± 3.7 |
| Tween20 | 10/10 | 300 | 300 | 17.5 ± 3.4 | 62.7 ± 11.6 |
| | 25/25 | 100 | 160 | 10.2 ± 0.8 | 41.4 ± 3.6 |
| | | 100 | 300 | 12.0 ± 0.5 | 52.7 ± 2.2 |
| | | 300 | 300 | 44.2 ± 3.9 | 57.4 ± 2.5 |
| Tween80 | 10/10 | 300 | 300 | 15.3 ± 1.0 | 55.4 ± 3.7 |
| | 25/25 | 100 | 160 | 12.8 ± 0.8 | 51.2 ± 3.5 |
| | | 100 | 300 | 14.3 ± 0.7 | 63.1 ± 3.3 |
| | | 300 | 300 | 54.7 ± 4.9 | 71.4 ± 9.9 |
| Span80 | 33/33 | 100 | 300 | 4.0 ± 0.95 | 11.9 ± 2.3 |

The 10 wt % CBD/10 wt % F68 formulation did not yield a stable colloid, but as FIG. 5B illustrates, use of the 10 wt % CBD/10 wt % F68 colloid of Example 6 results in reduced film formation, i.e. improved mixing of the CBD into the brewed coffee beverage, relative to the use of pure CBD powder (FIG. 5A). As Table 4 shows, increasing the amount of hot water flowed through the coffee grounds (i.e. increasing the volume of the brewed coffee beverage) allows for the extraction of greater quantities of CBD from F68 formulations, although the small increase in total mass of CBD extracted in the 500 μL/300 mL beverage compared to the 300 μL/300 mL beverage may indicate that there is an upper limit on the amount of CBD that can be extracted from F68 formulations in a single 300 mL extraction. Without wishing to be bound by any particular theory, the present inventors hypothesize that more concentrated droplets may be effective to increase the CBD extraction from F68 formulations.

Use of CBD/Tween20 and CBD/Tween80 formulations resulted in highly efficient, controlled CBD extractions in amounts between 10 mg and 44 mg (for Tween20 formulations) or between 12 mg and 55 mg (for Tween80 formulations), as shown in Table 4. Extractions using the 25 wt % CBD/25 wt % Tween formulations showed a stronger dependence on the amount of CBD colloid used than on the volume of water used for extraction; this demonstrates that that the use of Tween20 and/or Tween80 as the surfactant can result in fast elution of the CBD, and that the concentration and amount of the CBD/Tween colloid used can therefore be used to control CBD dosing of the final coffee beverage.

Tween20 and Tween80 are very similar sorbitan derivatives whose only difference is in the length of the hydrocarbon chain (Tween20's hydrocarbon chain has twelve carbon atoms, while Tween80's has eighteen), and because they both have HLB values and yield oil-in-water emulsions, the present inventors hypothesize, without wishing to be bound by any particular theory, that in colloids using either Tween surfactant, the hydrophobic segment is contained in the CBD oil droplet phase and the hydrophilic segment is exposed at the surface of the oil droplet. Thus, again without wishing to be bound by any particular theory, while different Tween surfactants may vary to a small degree in certain characteristics—by way of non-limiting example, Tween80 may have slightly stronger affinity for CBD and thereby make the CBD colloid droplets slightly more durable, and/or extraction efficiency may be improved by using Tween20 at low concentrations but Tween80 formulations at higher concentrations (as shown in Table 4)—the present inventors hypothesize that Tween20 and Tween80 can be used essentially interchangeably in formulations according to the present disclosure.

Because Span80 is a water-in-oil emulsifier, the amounts of CBD and surfactant had to be increased to 33 wt % to yield a stable colloid. Due to the higher hydrophobicity of this formulation, it was expected that the extraction efficiency would be lower than the Tween formulations, but the Span80 formulation did still yield small CBD extractions with low variability. While the efficiency of CBD extraction from formulations made using the other surfactants depended most strongly on the concentration and volume of the CBD colloid itself, it is expected that Span80 extraction efficiency will depend more strongly on the volume of water used for the extraction. Span80 may therefore be useful to provide controlled, smaller doses of CBD, although in some embodiments the use of a second, additional surfactant may be desired to improve the dispersibility of CBD droplets in aqueous solution and counteract Span80's tendency to promote formation of a CBD film in the finished coffee beverage.

This Example thus demonstrates that the use of equal weights of surfactant and CBD is effective to solubilize the CBD before and during extraction and thus to provide more consistent amounts of CBD relative to the use of a pure, non-solubilized CBD powder. The extracted CBD nanoparticles also remain much more effectively dispersed in the brewed coffee beverage, improving CBD bioavailability and uptake in the consumer's gastrointestinal tract.

The coffee beverages brewed according to this Example exhibited a certain amount of CBD film formation, although to a considerably reduced extent relative to the use of pure CBD powder. This is because, in the use of Keurig single-serving coffee machines (and in conventional drip coffee makers), the water used is at or near its boiling point, which in any event is much higher than the melting point of CBD (66° C.), and the colloid droplets therefore cannot resist these high temperatures, causing coalescence of the CBD. In some embodiments, therefore, it may be desirable to brew the coffee beverage at a lower temperature, or to brew a conventional (non-CBD-containing) coffee beverage at typical near-boiling temperatures and then mix in a CBD colloid as described herein after the coffee beverage has cooled to below the melting point of CBD (but still at or above the temperature at which the consumer desires to consume the coffee, which on average is about 60° C.); it is to be expressly understood that such embodiments are within the scope of the present disclosure.

### EXAMPLE 9

### CBD Extraction in Brewed Coffee Beverage—Commercial CBD Coffee Containers

Four varieties of commercially available single-serving coffee containers that contain CBD were purchased: three varieties of Strava Craft Coffee containers (marketed as including 4 mg, 10 mg, and 20 mg of CBD, respectively) and Isodiol “Pot-o-Coffee” containers (which are not marketed as having a specific CBD content), all adapted for use in a Keurig single-serving coffee machine. Both Strava and Isodiol use infusion techniques to incorporate CBD into coffee grounds.

Coffee grounds from each variety of container were soaked in ethanol for hours or days to extract the CBD, and the ethanol CBD extract was subjected to HPLC to assess the ethanol content. The amounts of CBD extracted from each container averaged 5.6 mg from the “4 mg” Strava containers, 12.9 mg from the “10 mg” Strava containers, 20.5 mg from the “20 mg” Strava containers, and 5.6 mg from the Isodiol containers.

The same varieties of containers were then used in a Keurig single-serving coffee machine to brew coffee beverages, according to the package directions, and the CBD content was assessed by HPLC as described in Example 7. The results are given in Table 5.

TABLE 5

| | Beverage | CBD in |
|---|---|---|
| | volume | beverage |
| Container type | (mL) | (mg) |
| Strava “4 mg” | 160 | 0.35 |
| | 300 | 0.41 |
| Strava “10 mg” | 300 | 0.35 |
| Strava “20 mg” | 300 | 0.49 |
| Isodiol | 160 | 0.26 |
| | 300 | 0.35 |

The “10 mg” and “20 mg” Strava containers, and the “4 mg” Strava container used for the 160 mL extraction, were subjected to a second extraction process using an equal volume of water. In the second extraction, the “4 mg” container yielded an additional 0.63 mg CBD (for a total of 0.98 mg), the “10 mg” container yielded an additional 0.38 mg CBD (for a total of 0.73 mg), and the “20 mg” container yielded an additional 0.20 mg CBD (for a total of 0.69 mg).

The concepts illustratively disclosed herein suitably may be practiced in the absence of any element which is not specifically disclosed herein. It is apparent to those skilled in the art, however, that many changes, variations, modifications, other uses, and applications of the disclosure are possible, and also changes, variations, modifications, other uses, and applications which do not depart from the spirit and scope of the disclosure are deemed to be covered by the disclosure.

The foregoing discussion has been presented for purposes of illustration and description. The foregoing is not intended to limit the disclosure to the form or forms disclosed herein. In the foregoing Detailed Description, for example, various features are grouped together in one or more embodiments for the purpose of streamlining the disclosure. The features of the embodiments may be combined in alternate embodiments other than those discussed above. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment.

Moreover, though the present disclosure has included description of one or more embodiments and certain variations and modifications, other variations, combinations, and modifications are within the scope of the disclosure, e.g. as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, whether or not such alternate, interchangeable, and/or equivalent structures, functions, ranges, or steps are disclosed herein, and without intending to publicly dedicate any patentable subject matter.

1. A hydrophilic thin film for adding cannabidiol to a beverage, comprising:
a carrier material, comprising an edible film-forming polymer; and
cannabidiol (CBD) nanoparticles, dispersed throughout the carrier material,
wherein the carrier material is configured to dissolve or disintegrate upon exposure to a hot aqueous liquid to release the CBD nanoparticles into the hot aqueous liquid.

2. The hydrophilic thin film of claim 1, wherein the CBD nanoparticles are colloidally dispersed throughout the carrier material.

3. The hydrophilic thin film of claim 1, wherein the edible film-forming polymer is selected from the group consisting of pullulan, hydroxypropyl methylcellulose, carboxymethyl cellulose, sodium carboxymethyl cellulose, hydroxypropyl cellulose, alginate, pectin, carrageenan, gelatin, starch, and gum arabic.

4. The hydrophilic thin film of claim 1, further comprising a nonionic surfactant.

5. The hydrophilic thin film of claim 4, wherein the nonionic surfactant is a poloxamer.

6. A method for making a hydrophilic thin film, comprising:
synthesizing a dispersion of cannabidiol (CBD) nanoparticles in a medium comprising a hydrophilic, edible, film-forming polymer;
placing a predetermined volume of the dispersion of CBD nanoparticles in a cavity of a container; and
removing water from the dispersion of CBD nanoparticles to form the hydrophilic thin film.

7. The method of claim 6, wherein the synthesizing step comprises the sub-steps of:
combining CBD and an aqueous solvent to form a mixture;
heating the mixture to melt the CBD to form an aqueous nanosuspension;
adding a nonionic surfactant to the aqueous nanosuspension;
sonicating and/or cooling the aqueous nanosuspension; and
mixing the aqueous nanosuspension with an aqueous solution of the hydrophilic, edible, film-forming polymer.

8. The method of claim 6, wherein the hydrophilic, edible, film-forming polymer is selected from the group consisting of pullulan, hydroxypropyl methylcellulose, carboxymethyl cellulose, sodium carboxymethyl cellulose, hydroxypropyl cellulose, alginate, pectin, carrageenan, gelatin, starch, and gum arabic.

9. The method of claim 6, wherein the removing step is carried out by heating the dispersion of CBD nanoparticles.

10. The method of claim 6, wherein the removing step is carried out by lyophilizing the dispersion of CBD nanoparticles.

11. A container for preparation of a single serving of a beverage, comprising:
a body defining a cavity;
a packed bed of a dry beverage precursor ingredient, disposed within the cavity; and
a colloid comprising cannabidiol (CBD) nanoparticles and at least one surfactant, wherein the colloid is distributed throughout at least a portion of the packed bed.

12. The container of claim 11, wherein the dry beverage precursor ingredient is selected from the group consisting of ground coffee beans, tea leaves, and a powdered hot chocolate mix.

13. The container of claim 11, wherein the at least one surfactant is selected from the group consisting of Tween20, Tween80, Span80, Pluronic F68, sucrose esters, and sodium stearoyl lactylate.

14. The container of claim 11, wherein the CBD nanoparticles and the at least one surfactant are present in the colloid in approximately equal amounts by weight.

15. The container of claim 14, wherein the CBD nanoparticles and the at least one surfactant are each present in the colloid in an amount of between about 5 wt % and about 50 wt %.

16. The container of claim 15, wherein the CBD nanoparticles and the at least one surfactant are each present in the colloid in an amount of between about 10 wt % and about 33 wt %.

17. The container of claim 11, wherein the body comprises a first puncturable portion associated with an upper portion of the cavity and a second puncturable portion associated with a lower portion of the cavity, wherein the container is configured such that, when the first and second puncturable portions of the body are punctured, an aqueous liquid may flow into the upper portion of the cavity, through the packed bed of the dry beverage precursor ingredient, and out of the lower portion of the cavity.

18. The container of claim 17, further comprising a filter configured to substantially prevent the dry beverage precursor ingredient from being carried out of the container due to flow of the aqueous liquid.

19. A method for making a cannabidiol (CBD)-containing beverage, comprising:
providing the container of claim 17;
puncturing the first and second puncturable portions of the body of the container; and
causing a hot aqueous liquid to flow (i) into the upper portion of the cavity, (ii) through the packed bed to extract at least one chemical compound from the dry beverage precursor ingredient and at least a portion of the CBD, and (iii) out of the lower portion of the cavity.

20. The method of claim 19, wherein the dry beverage precursor ingredient is selected from the group consisting of ground coffee beans, tea leaves, and a powdered hot chocolate mix.
